(19) United States
(12) Patent Application Publication
(10) Pub. No.: US 2026/0267313 A1
(43) Pub. Date: Sep. 10, 2026

(54) INFORMATION GENERATION DEVICE AND INFORMATION DISPLAY DEVICE

(71) Applicant: FANUC CORPORATION, Yamanashi (JP)

(72) Inventors: Kouhei OOI, Yamanashi (JP); Toshihiro WATANABE, Yamanashi (JP); Tooru KUBOTA, Yamanashi (JP)

(73) Assignee: FANUC CORPORATION, Yamanashi (JP)

(21) Appl. No.: 19/167,835

(22) PCT Filed: Mar. 30, 2023
(86) PCT No.: PCT/JP2023/013256

§ 371 Date: Sep. 22, 2025

(51) Int. Cl. G05B 19/4068; G06T 11/23

(52) U.S. Cl. CPC G05B 19/4068; G06T 11/23; G05B 2219/32128; G05B 2219/36204

(57) ABSTRACT

Provided is a technique enabling the positional relationship between a workpiece and a tool on a program-based movement path to be ascertained easily. An information generation device 10 includes: an analysis unit 11 for generating, from a program, command data including at least a prescribed position of a tool 20 at a prescribed point on a movement path and a relative indexing angle between a workpiece and the tool 20 with respect to the prescribed position; a tool shape acquisition unit 12 for acquiring shape information of one or more components constituting the tool 20; and a data output unit 13 for outputting data for confirmation that includes the relative positions of the tool 20 and the workpiece W on a movement path generated by interpolating the prescribed position on the basis of the command data and the shape information and that includes the indexing angle and the shape information.

### TECHNICAL FIELD

The present disclosure relates to an information generation device and an information display device.

### BACKGROUND ART

Conventionally, in order to machine a workpiece into a complicated shape with a single lathe tool, there has been known a machining method of performing lathe machining on the workpiece while dynamically changing the indexing angle of the tool with respect to the workpiece. In machining of this type, a blade edge position and the indexing angle are commanded to each block of a program, and a linear axis and a rotation axis are controlled based on these commands and a preset tool offset. The tool control technique of this type is described, for example, in Patent Documents 1 to 3.

### CITATION LIST

### Patent Document

Patent Document 1: Japanese Unexamined Patent Application, Publication No. 2011-083830

Patent Document 2: PCT International Publication No. WO2021/014517

Patent Document 3: PCT International Publication No. WO2011/096327

### DISCLOSURE OF THE INVENTION

### Problems to be Solved by the Invention

In a case where an operator creates the program by oneself, the operator determines operation of the tool and the workpiece and occurrence of interference with reference to a program command value. However, only with the program command value, it is difficult to grasp a positional relationship between the tool and the workpiece, which leads to difficulty in determining occurrence of interference. Operation based on the program may be checked after machining with a machine tool has been stopped, but such a process is complicated because information, such as a coordinate value for each axis and a modal, up to a point at which the program is edited needs to be recovered.

The present disclosure has been made in view of the problems above, and an object thereof is to provide a technique capable of easily grasping a positional relationship between a tool and a workpiece on a movement route based on a program.

### Means for Solving the Problems

The present disclosure is an information generation device for generating information on a program for performing lathe machining on a workpiece with a tool, which includes an analysis unit that generates, from the program, command data including at least a predetermined position of the tool at a predetermined point on a movement route and a relative indexing angle between the tool and the workpiece at the predetermined position, a tool shape acquisition unit that acquires shape information on at least one or more components forming the tool, and a data output unit that outputs, based on the command data and the shape information, confirmation data including the relative positions of the workpiece and the tool on the movement route generated by interpolation performed on the predetermined position, the indexing angle, and the shape information.

### Effects of the Invention

According to the present disclosure, the technique capable of easily grasping the positional relationship between the tool and the workpiece on the movement route based on the program can be provided.

### BRIEF DESCRIPTION OF THE DRAWINGS

FIG. 1 is a block diagram showing the configuration of an information generation device according to a first embodiment;

FIG. 2 is a view showing one example of a program command;

FIG. 3 is a table showing the behavior of a tool specified by the program command;

FIG. 4 is a view schematically showing one example of components of the tool;

FIG. 5 is a view schematically showing one example of tool shape information;

FIG. 6 is a view showing one example of a position and an indexing angle interpolated by interpolation processing;

FIG. 7 is a view for describing the tool shape information before and after a change by rotation;

FIG. 8 is a view showing one example of the tool shape information after the change by rotation, which corresponds to the interpolated position;

FIG. 9 is a block diagram showing the configuration of an information generation device according to a second embodiment;

FIG. 10 is a view for describing interference determination by an interference determination unit;

FIG. 11 is a view showing one example of an interference determination result obtained by the interference determination unit;

FIG. 12 is a block diagram showing the configuration of an information display device according to a third embodiment; and

FIG. 13 is a block diagram showing the configuration of an information display device according to a fourth embodiment.

### PREFERRED MODE FOR CARRYING OUT THE INVENTION

Hereinafter, embodiments of the present disclosure will be described in detail with reference to the drawings. Note that in description of a second embodiment and embodiments subsequent thereto, the same reference numerals are used to represent components common to those of a first embodiment and description thereof will be omitted as necessary.

### First Embodiment

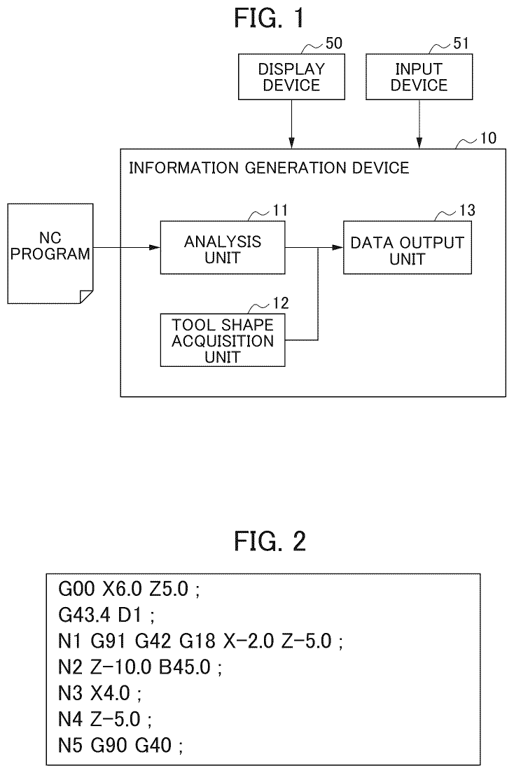

FIG. 1 is a block diagram showing the configuration of an information generation device 10 according to the first embodiment. The information generation device 10 is an information processing device that generates information on a program for performing lathe machining on a workpiece with a tool of a machine tool.

The machine tool is, for example, a combined lathe having a mechanism that oscillates the tool. The machine tool program is, for example, an NC program for controlling operation of the machine tool. For the program, a command value and the like for controlling machining, such as the position of a predetermined point (spot) on a tool movement route, a tool movement method, a tool movement amount, and a relative indexing angle between the tool and the workpiece, are set. Some of the command values may be parameters set in advance for the machine tool. The machine tool performs lathe machining on the workpiece based on the program command values, the parameters set in advance for the machine tool, and the like.

The information generation device 10 is, for example, a computer including a memory such as a read only memory (ROM) or a random access memory (RAM), a central processing unit (CPU), and a communication control unit connected to each other via a bus. The information generation device 10 may be a numerical control device that controls machining, or may be a computer for creating a program independently of the machine tool.

A display device 50 and an input device 51 are connected to the information generation device 10 of the present embodiment. The display device 50 is a display that provides various types of information to an operator via an image, sound, or both. The input device 51 is an interface to be operated by the operator so that the operator can input various settings regarding machining and the machine tool. The display device 50 and the input device 51 may be independent of each other, or may be configured as an integrated touch panel display. As described above, the configurations of the display device 50 and the input device 51 are not particularly limited.

The information generation device 10 includes, as functional units operated by the above-described CPU, an analysis unit 11, a tool shape acquisition unit 12, and a data output unit 13. The function and operation of each functional unit of the information generation device 10 are implemented in such a manner that the above-described CPU and memory and a control program stored in the memory cooperate with each other. Each functional unit will be described.

The analysis unit 11 analyzes the program to acquire operation information for determining operation of the tool. The operation information includes, for example, information for identifying a movement route of the position of the tip end of the tool. The movement route corresponds to the shape of the workpiece. The movement route is described in the program command by dividing the movement route into a plurality of blocks. For each block, position information on a start point indicating an initial position of the tool, an end point indicating an end position, and the like and the type of movement are set.

The analysis unit 11 of the present embodiment acquires, from the program, operation information including a point at a predetermined position on the movement route in each block and a relative indexing angle between the tool and the workpiece at the point at the predetermined position. The point at the predetermined position in each block is, for example, the above-described start or end point of the block or an interpolation point indicating the position of the tool between the start point and the end point. The analysis unit 11 generates, based on the operation information, command data including the point at the predetermined position on the movement route in each block and the relative indexing angle between the tool and the workpiece at the point at the predetermined position.

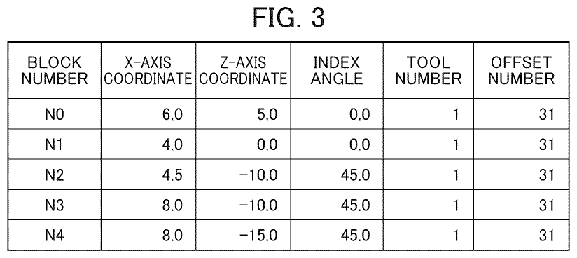

An analysis example of the analysis unit 11 will be described with reference to FIGS. 2 and 3. In the following description, the point at the predetermined position in the block will be described as the end point of the block. FIG. 2 is a view showing one example of the program command. FIG. 3 is a table showing the behavior of the tool specified by the program command.

N0 to N4 shown in FIG. 3 indicate each block in the program command.
“G00” is a command for specifying a linear behavior or coordinate in positioning, linear interpolation, or the like.
“G43.4” is a command for starting tool tip end point control.
“G91” is an incremental command for commanding a movement amount from a current position.
“G42” is a command for setting correction on the tool route specified by the program and a correction direction (for example, rightward with respect to a traveling direction).
“G18” is a command for specifying a plane on which the correction or the like is executed to a ZX plane.
“G90” is an absolute command for setting one origin point (origin) and commanding a numerical value from the origin point to a destination.
“G40” is a command for canceling tool diameter correction.
For each block, “X” specifies an X-coordinate, and “Z” specifies a Z-coordinate. The position of the blade edge of the tool is determined by the X-coordinate and the Z-coordinate.
“D” is description for determining a correction amount, and in this example, a correction amount set in advance for D1 is invoked.
“B” is an indexing angle specified by the program command.

The analysis unit 11 generates, from the program of FIG. 2, the command data indicating the behavior of the tool 20, such as the position of the blade edge and the indexing angle, as shown in FIG. 3. A tool number in the table of FIG. 3 indicates a tool shape, and an offset number indicates a correction amount by which the position of the tool is shifted in a predetermined direction. As the offset number, the correction amount is set, for example, in consideration of the shape of the tool. Different offset numbers are set between the case of a single blade edge and the case of three blade edges. The offset number may also be referred to as blade edge identification information.

The tool shape acquisition unit 12 acquires shape information on the shape of a component forming the tool on a plane on which lathe machining is performed. The component includes, for example, a turret, a holder, a shank, a blade edge, and the like. The tool shape acquisition unit 12 may acquire the shape information from the command value of the program, or may acquire the shape information from a storage unit (not shown) outside the information generation device 10.

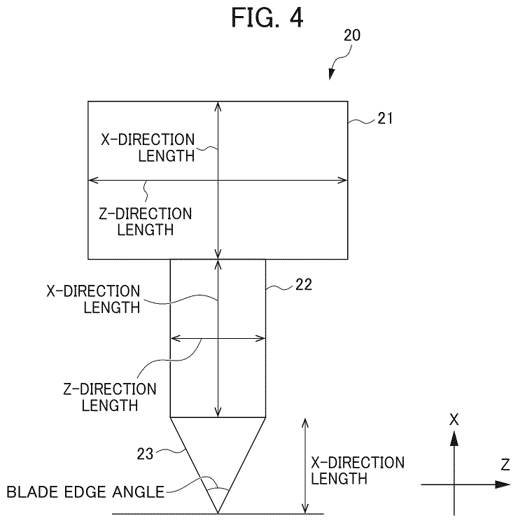

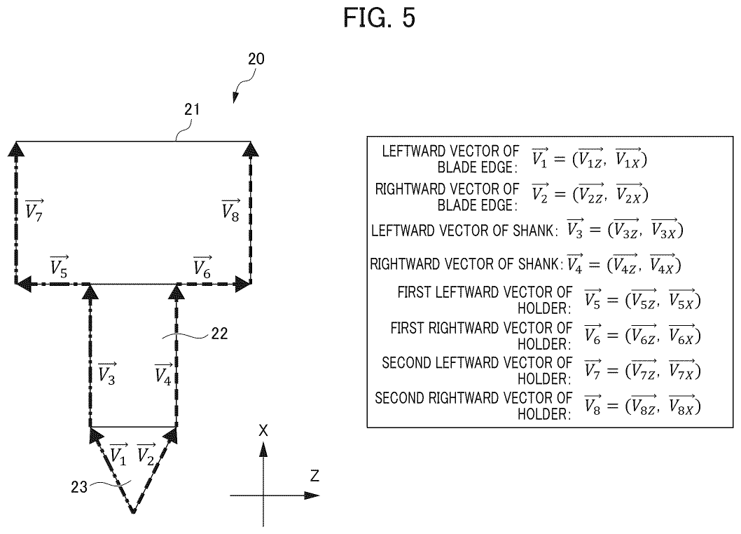

An example of acquisition of the shape information by the tool shape acquisition unit 12 will be described with reference to FIGS. 4 and 5. FIG. 4 is a view schematically showing one example of the components of the tool 20. FIG. 4 shows a plurality of components 21 to 23 of the tool 20. The shape information is, for example, information indicating the shapes of the components 21 to 23 on the ZX plane on which cutting is performed.

The component 21 is a holder (or turret such as tool post or blade rest) of the tool 20. The component 22 is a shank of the tool 20. The component 23 is a blade edge of the tool 20. In this example, the tool shape acquisition unit 12 acquires the lengths of the component 21 and the component 22 in the X-axis direction and the Z-axis direction, and acquires the length of the component 23 in the X-axis direction and the blade edge angle of the component 23.

FIG. 5 is a view schematically showing one example of the shape information on the tool 20. As shown in FIG. 5, the tool shape acquisition unit 12 obtains vectors tracing end points of each element rightward and leftward from the blade edge based on the information on the lengths of the components 21 to 23 in the X-axis direction and the Z-axis direction and the blade edge angle.

FIG. 5 shows the leftward vectors in the plane of paper by chain lines, and shows the rightward vectors in the plane of paper by dashed lines. In the example of FIG. 5, the shape information on the component 23 is a leftward vector V₁ and a rightward vector V₂ of the blade edge. The leftward vector V₁ of the blade edge includes a component V_{1Z} in the Z-direction and a component V_{1X} in the X-direction, and the rightward vector V₂ of the blade edge includes a component V_{2Z} in the Z-direction and a component V_{2X} in the X-direction. The shape information on the component 22 is a leftward vector V₃ and a rightward vector V₄ of the shank. The leftward vector V₃ of the shank includes a component V_{3Z} in the Z-direction and a component V_{3X} in the X-direction, and the rightward vector V₄ of the shank includes a component V_{4Z} in the Z-direction and a component V_{4X} in the X-direction. The shape information on the component 21 is a first leftward vector V₅, a first rightward vector V₆, a second leftward vector V₇, and a second rightward vector V₈ of the holder. These vectors also include vectors in the Z-direction and the X-direction. That is, the first leftward vector V₅ includes components V_{5Z}, V_{5X}, the first rightward vector Ve includes components V_{6Z}, V_{6X}, the second leftward vector V₇ includes components V_{7Z}, V_{7X}, and the second rightward vector V₈ includes components V_{8Z}, V_{8X}. As the shape on the ZX plane becomes more complicated and the number of sides to be taken into consideration increases, the number of vectors as the shape information increases.

Note that in this example, the indexing angle B is an angle indicating the inclination of the tool 20, which is 0 degrees (reference angle) when the direction of a virtual straight line from the tip end side (blade edge side) to the base end side of the tool 20 is coincident with a direction perpendicular to the Z-axis direction. The tool 20 is in a standing state when B=0, and an inclination direction is determined according to the positive or negative sign of B. A side to which the positive or negative sign is set is arbitrary. In this example, it is set such that leftward inclination from the standing state in the plane of paper indicates inclination to the positive side and rightward inclination from the standing state in the plane of paper indicates inclination to the negative side.

Next, the data output unit 13 will be described. The data output unit 13 generates confirmation data based on the analysis result from the analysis unit 11 and the shape information acquired by the tool shape acquisition unit 12. The data output unit 13 of the present embodiment executes interpolation processing of interpolating a position between predetermined points specified by the program command and rotation processing of generating tool shape information after rotation based on the indexing angle, thereby generating the confirmation data.

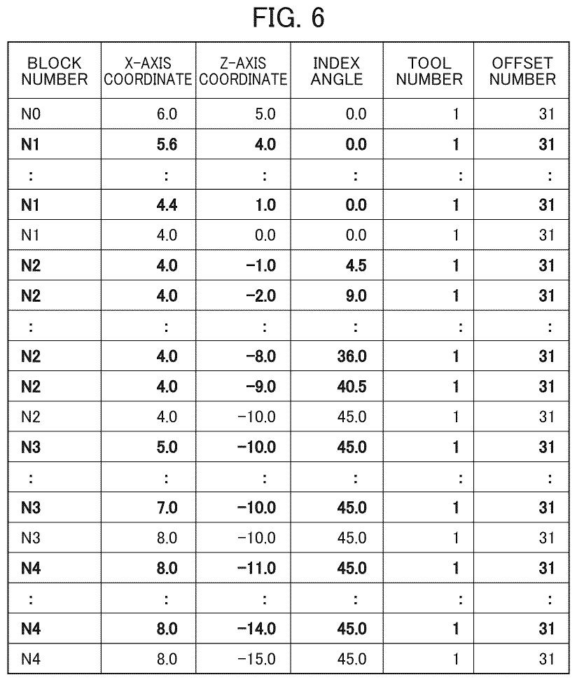

First, the interpolation processing by the data output unit 13 will be described with reference to FIG. 6. FIG. 6 is a view showing one example of positions and indexing angles interpolated by the interpolation processing. The data output unit 13 executes the interpolation processing to compute the X- and Z-coordinate values of the tip end point of the tool 20 between the predetermined points (for example, up to the end point) in each block, thereby acquiring the interpolated positions not set as command values and computing the indexing angles corresponding to the interpolated positions.

The indexing angle corresponding to the interpolated position is computed in a stepwise manner until a target angle. For example, in transition from the block N1 to the block N2, the indexing angles are set in a stepwise manner from an indexing angle of 0° in the block N1 to a target angle of 45° which is a command value for the block N2. In this example, after transition to the block N2, the indexing angle is increased by 4.5° for each interpolated position, and eventually reaches 45°. Note that the indexing angle interpolation angle is not limited to this method.

Moreover, a tool number and an offset number are set as a tool shape corresponding to the interpolated position. As the tool number and the offset number, parameters set for a certain block or a block before such a block may be set, for example. In this example, for N0 to N4, the same parameters are set for all the positions including the interpolated positions.

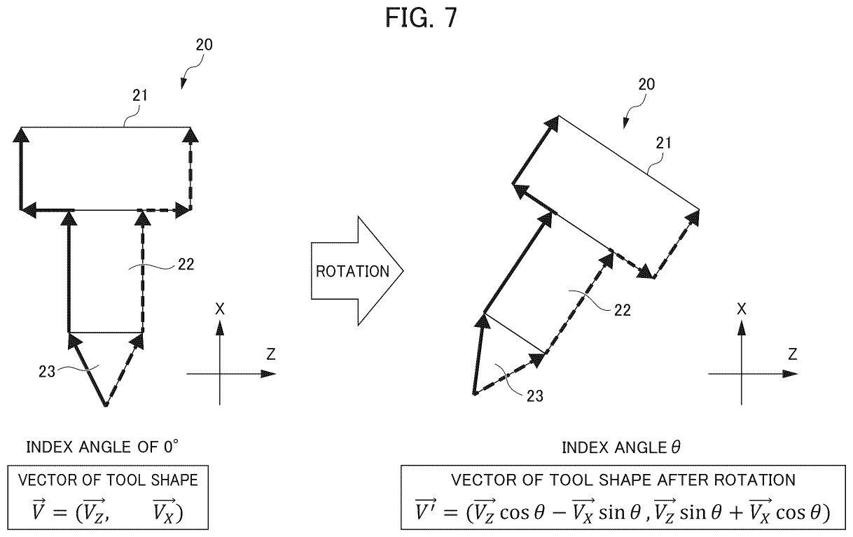

Next, the rotation processing by the data output unit 13 will be described with reference to FIG. 7. FIG. 7 is a view for describing the shape information on the tool 20 before and after a change by rotation. As shown in FIG. 7, the vector of the tool shape at an indexing angle of 0° is taken as Mathematical Expression (1). The vector of the tool shape after the tool 20 has been rotated an angle θ from the state at an indexing angle of 0° with the center of the tip end of the tool 20 as a rotation axis can be expressed by Mathematical Expression (2) based on Mathematical Expression (1).

$$[ Mathematical Expression 1 ]$$

$$\begin{matrix}[ \text{?} 1 ] & \\ \vec{V} = ( \vec{{V}_{Z}} , \vec{{V}_{X}} ) & Mathematical Expression ( 1 )\end{matrix}$$

$$[ Mathematical Expression 2 ]$$

$$\vec{{V}^{′}} = ( \vec{{V}_{Z}} cos θ - \vec{{V}_{X}} sin θ , \vec{{V}_{Z}} sin θ + \vec{{V}_{X}} cos θ ) \qquad Mathematical Expression ( 2 )$$

The data output unit 13 generates the shape information after rotation based on the predetermined position of the tool 20 at the predetermined point and the indexing angle at the interpolated position. Then, the data output unit 13 stores the interpolated position generated by the interpolation processing and the shape information on the tool 20 after the change by rotation, which corresponds to the interpolated position, in association with each other.

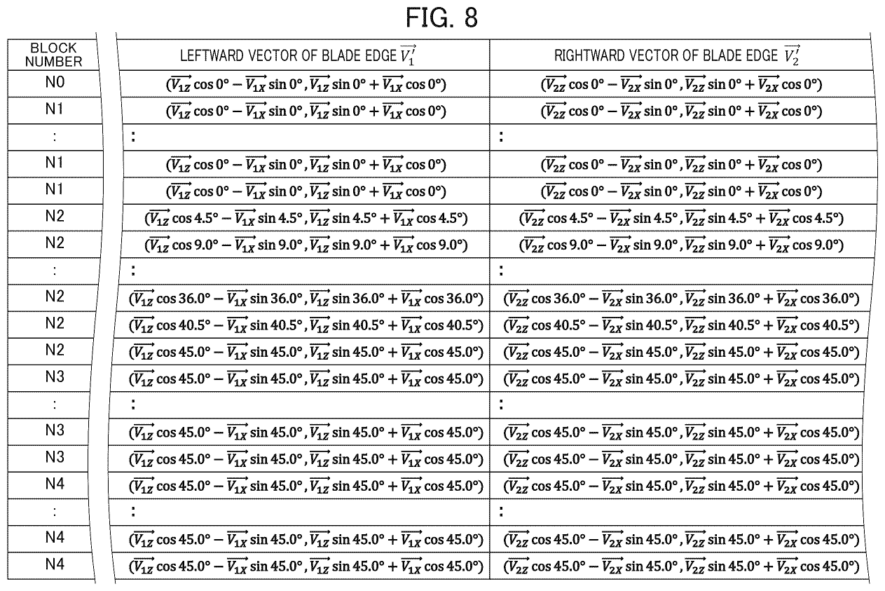

One example of the shape information on the tool 20, which is associated with the interpolated position, will be described with reference to FIG. 8. FIG. 8 is a view showing one example of the shape information on the tool 20 after the change by rotation, which corresponds to the interpolated position. FIG. 8 shows, for each interpolated position, the shape information after rotation, which is calculated as part of the confirmation data according to Mathematical Expression (2). Note that FIG. 8 shows only the vectors of the component 23, which is the blade edge, corresponding to the interpolated positions of the blocks due to limitations of space, but the items shown in FIG. 6, such as the vectors of the other components 21, 22, the Z-axis coordinates, the X-axis coordinates, and the indexing angles, may also be displayed.

The data output unit 13 generates the information as shown in FIG. 6 or 8 as the confirmation data. The data output unit 13 outputs the confirmation data to the display device 50 or an external device such as a computer (not shown).

According to the information generation device 10 of the present embodiment as described above, the following effects are obtained. The information generation device 10 includes the analysis unit 11 that generates, from the program, the command data including at least the predetermined position of the tool 20 at the predetermined point on the movement route and the relative indexing angle between the tool 20 and the workpiece W at the predetermined position, the tool shape acquisition unit 12 that acquires the shape information on at least one or more components forming the tool 20, and the data output unit 13 that outputs, based on the command data and the shape information, the confirmation data including the relative positions of the workpiece W and the tool 20 on the movement route generated by interpolation performed on the predetermined position, the indexing angle, and the shape information.

With this configuration, even in a case where the operator manually creates the program, the information for checking operation of the tool 20 and the workpiece W and occurrence of interference can be generated based on the information on the program command value.

Moreover, in the present embodiment, the components 21 to 23 are at least one or more selected from a turret that stores the tool 20, a holder that stores the tool 20, a shank of the tool 20, or a blade edge of the tool 20.

With this configuration, the confirmation data which can be checked by the operator can be generated in consideration of the shape of the tool 20 actually used for cutting.

Further, in the present embodiment, the data output unit 13 acquires the indexing angle corresponding to the relative positions of the workpiece W and the tool 20 on the movement route, executes the rotation processing of rotating the shape information according to the acquired indexing angle, and outputs, as the confirmation data, the shape information after rotation in association with the relative positions of the workpiece W and the tool 20.

With this configuration, the shape information on which the indexing angle is reflected can be included in the confirmation data, and the state (angle) of the tool shape in a machining stage can be grasped.

### Second Embodiment

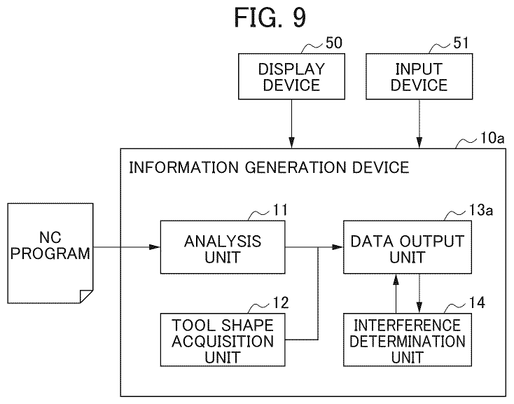

One example of the information generation device 10 of the first embodiment has been described above, but the present disclosure is not limited to this configuration. Next, an information generation device 10a of the second embodiment will be described with reference to FIG. 9. FIG. 9 is a block diagram showing the configuration of the information generation device 10a according to the second embodiment.

As shown in FIG. 9, the information generation device 10a of the second embodiment is different in that an interference determination unit 14 is further provided. The interference determination unit 14 determines occurrence of interference of a tool 20.

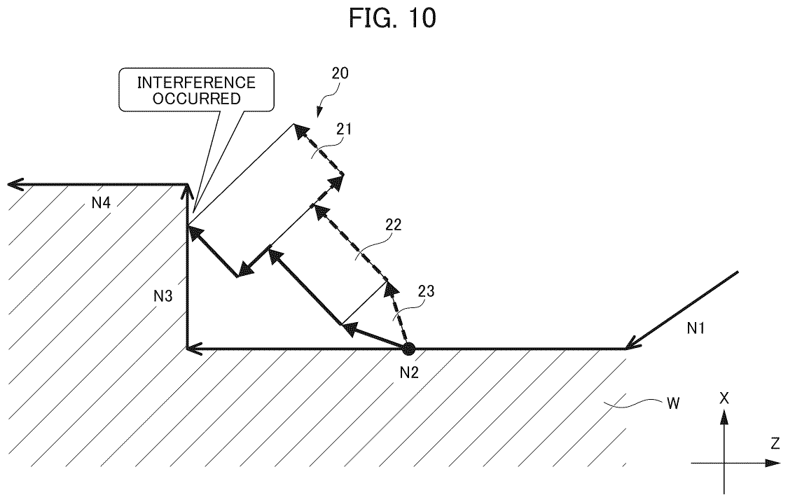

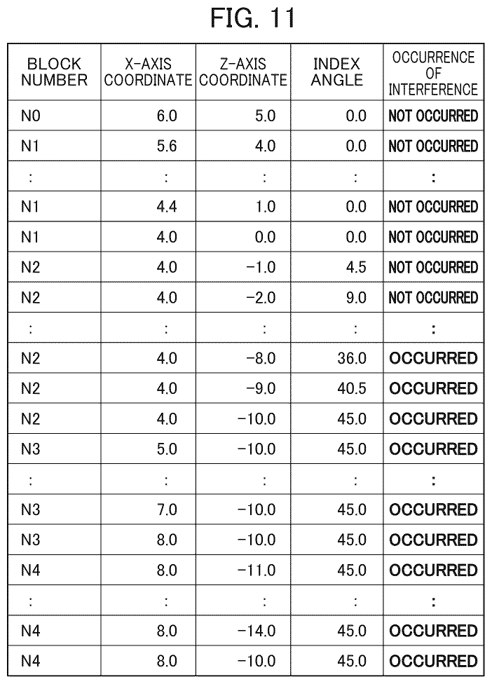

FIG. 10 is a view for describing interference determination by the interference determination unit 14. As shown in FIG. 10, a program route (movement route of the tip end of the tool 20) of each of blocks N1 to N4 defines the outer shape of a workpiece W. The interference determination unit 14 determines whether or not the movement route of the tool 20 and shape information (components 21 to 23) contact each other.

The tool movement route is a movement route based on command data, which is interpolated by a data output unit 13a. The shape information on the tool 20 is the vectors of the components 21 to 23, and is shape information after rotation, on which an indexing angle is reflected.

In a case where there are other mechanical structures (chuck, tailstock, and the like) for the workpiece W, the interference determination unit 14 sets the range of the indexing angle in consideration of interference not only with the workpiece W but also with the other mechanical structures. For example, the interference determination unit 14 determines, based on shape information on the other mechanical structures, whether or not there is interference between the tool 20 and the other mechanical structures. As the determination method, the same method as a method for detecting interference between the tool 20 and the workpiece W may be used.

FIG. 11 is a view showing one example of an interference determination result obtained by the interference determination unit 14. As shown in FIG. 11, the interference determination unit 14 determines interference for a predetermined position and an interpolated position on an interpolated movement route. The data output unit 13a outputs, as confirmation data, the determination result to an external display device 50 in association with the predetermined position and the interpolated position on the movement route.

As described above, in the second embodiment, the following effects are obtained in addition to the effects obtained in the first embodiment.

The information generation device 10a of the second embodiment further includes the interference determination unit 14 that determines occurrence of interference of the tool 20 based on the relative positions of the tool 20 and the workpiece W and the indexing angle in the confirmation data, and the data output unit 13a includes, in the confirmation data, the determination result obtained by the interference determination unit 14.

With this configuration, occurrence of interference of the tool 20 at the predetermined position and the interpolated position on the movement route can be grasped using the external device such as the display device 50.

Moreover, in the second embodiment, the interference determination unit 14 determines interference in consideration of the mechanical structure that performs lathe machining.

With this configuration, interference with the mechanical structure can also be taken into consideration, and the probability of interference of the tool 20 can be more accurately grasped.

### Third Embodiment

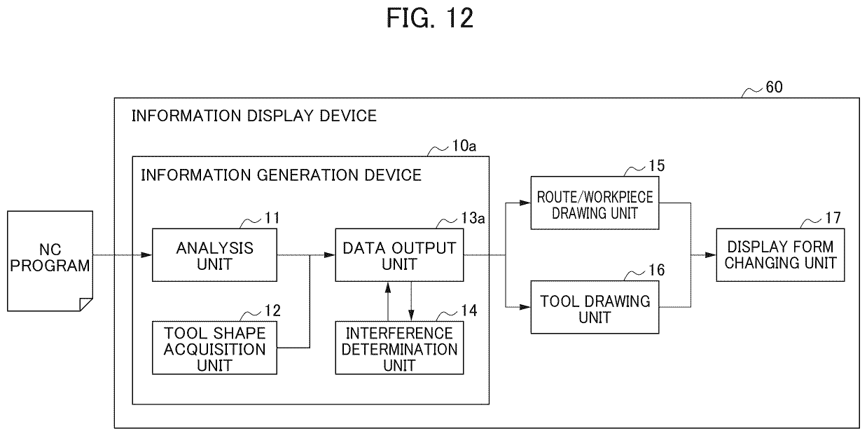

Next, an information display device 60 will be described with reference to FIG. 12. FIG. 12 is a block diagram showing the configuration of the information display device 60 according to the third embodiment.

The information display device 60 is a display that provides various types of information to an operator via an image, sound, or both, and is also an information processing device that executes image drawing processing. An input device 51 may be connected to the information display device 60 as in the embodiments above.

The information display device 60 of the third embodiment includes an information generation device 10a, a route/workpiece drawing unit 15, a tool drawing unit 16, and a display form changing unit 17. The information generation device 10a has a configuration similar to that of the information generation device 10a including the interference determination unit 14 as described in the second embodiment, and has a function of generating confirmation data.

The route/workpiece drawing unit 15 executes processing of drawing a movement route and a workpiece. The route/workpiece drawing unit 15 generates images of the movement route and the workpiece W, for example, based on a predetermined position and an interpolated position set in command data and the confirmation data.

The tool drawing unit 16 executes processing of drawing a tool 20 based on tool shape information included in the confirmation data. The tool drawing unit 16 generates an image of the tool 20, for example, based on shape information after rotation, on which an indexing angle is reflected.

The display form changing unit 17 executes drawing processing of displaying a spot in the confirmation data, which is determined by the interference determination unit 14 as interference occurred, in a form different from those of the other spots. As a method for displaying the spot in the different form, for example, a color, a pattern, or a shape may be changed, such as a change in the color or shape of a character or a figure in a table indicated by the confirmation data, or a text may be used. In a case where any of the tool 20, the workpiece W, the movement route, and the like is displayed in the form of figure, a vector indicating the outer shape of the figure or part of the movement route may be displayed in a different form. Further, a form changing over time, such as blinking, may also be used as the different display form.

By the drawing processing by the route/workpiece drawing unit 15, the tool drawing unit 16, and the display form changing unit 17, the information display device 60 displays information as shown in FIGS. 6, 8, and 11. Moreover, the information display device 60 may display image data in the form of program as shown in FIG. 2. The display form changing unit 17 displays a spot determined as interference occurred in a form different from that of a spot determined as interference not occurred.

By the drawing processing by the route/workpiece drawing unit 15, the tool drawing unit 16, and the display form changing unit 17, the information display device 60 displays an image indicating the outer shape of the tool 20, the outer shape of the workpiece W, and blocks N1 to N4 of the movement route as shown in FIG. 10. The information display device 60 visually provides a positional relationship to the operator via an image using a figure, a line, a color, and a text. The image using the figure as shown in FIG. 10 may be displayed together with the table as shown in FIG. 6, 8, or 11 or the program as shown in FIG. 2. Alternatively, the image using the figure as shown in FIG. 10 may be displayed in a form switched by selecting an intended block in the table or the program by an input device (not shown).

In this example, a text message of “INTERFERENCE OCCURRED” is displayed, but the text message of “INTERFERENCE OCCURRED” is not displayed at a position at which no interference occurs. That is, the information display device 60 of this example displays the position at which interference occurs and the position at which no interference occurs in different forms, i.e., with or without the text. As described above, the text can be used for display in the different forms.

As described above, in the third embodiment, the following effects are obtained in addition to the effects obtained in the first embodiment.

The information display device 60 of the third embodiment includes the information generation device 10a, the route/workpiece drawing unit 15 that draws the movement route and the workpiece W, the tool drawing unit 16 that draws the tool based on the confirmation data, and the display form changing unit 17 that displays, in a case where the interference determination unit 14 of the information generation device 10a determines that there is interference between the tool 20 and the workpiece W, at least any one of the drawn movement route, workpiece, or tool in the different form.

With this configuration, the states of the movement route, the workpiece, and the tool are drawn, and therefore, the operator can intuitively understand the contents of the confirmation data. In a case where there is interference, the movement route, the workpiece, and the tool are displayed in the different forms, and therefore, the operator can also intuitively and easily grasp occurrence of interference.

### Fourth Embodiment

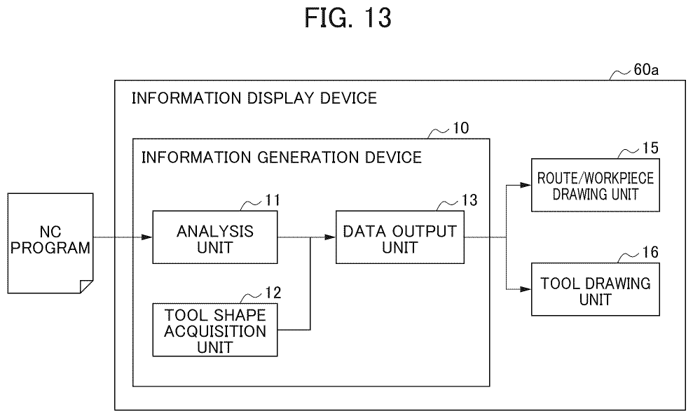

Next, an information display device 60a will be described with reference to FIG. 13. FIG. 13 is a block diagram showing the configuration of the information display device 60a according to the fourth embodiment.

As shown in FIG. 13, the information display device 60a of the fourth embodiment includes an information generation device 10, a route/workpiece drawing unit 15 that draws a movement route and a workpiece W, and a tool drawing unit 16 that draws a tool based on confirmation data.

The information display device 60a of the fourth embodiment is configured such that the display form changing unit 17 is omitted from the configuration of the third embodiment and the information generation device 10a is replaced with the information generation device 10 of the first embodiment. As described above, part of the configuration of the third embodiment may be omitted. In the fourth embodiment, interference determination by the interference determination unit 14 and the change in the display form based on the interference determination result by the display form changing unit 17 are not performed. With this configuration, the states of the movement route, the workpiece, and the tool can also be drawn by drawing processing by the route/workpiece drawing unit 15 and the tool drawing unit 16, and therefore, an operator can intuitively understand the contents of the confirmation data.

The present disclosure has been described in detail, but is not limited to each of the embodiments above. Various additions, replacements, changes, partial omissions, and the like may be made to these embodiments without departing from the gist of the present disclosure or without departing from the gist of the present disclosure derived from the contents described in the claims and the equivalents thereof. These embodiments may be implemented in combination. For example, in the embodiments above, the order of each type of operation and the order of each type of processing have been described as an example, and the present disclosure is not limited thereto. The same also applies to numerical values or mathematical expressions if used in the description of the embodiments above.

Further, the following additional remarks are disclosed regarding the embodiments and modifications above.

### (Additional Remark 1)

An information generation device (10, 10a) for generating information on a program for performing lathe machining on a workpiece (W) with a tool (20) includes
an analysis unit (11) that generates, from the program,
command data including at least a predetermined position of the tool (20) at a predetermined point on a movement route and a relative indexing angle between the tool (20) and the workpiece (W) at the predetermined position,
a tool shape acquisition unit (12) that acquires shape information on at least one or more components forming the tool (20), and
a data output unit (13, 13a) that outputs, based on the command data and the shape information, confirmation data including the relative positions of the workpiece (W) and the tool (20) on the movement route generated by interpolation performed on the predetermined position, the indexing angle,
and the shape information.

### (Additional Remark 2)

In the information generation device (10) above, the component is at least one or more selected from a turret that stores the tool (20), a holder that stores the tool (20), a shank of the tool (20), or a blade edge of the tool (20).

### (Additional Remark 3)

In the information generation device (10) above, the data output unit (13)
executes rotation processing of acquiring an indexing angle corresponding to the relative positions of the workpiece (W) and the tool (20) on the movement route and rotating the shape information according to the acquired indexing angle, and outputs, as the confirmation data, the shape information after rotation in association with the relative positions of the workpiece (W) and the tool (20).

### (Additional Remark 4)

The information generation device (10a) above further includes
an interference determination unit (14) that determines occurrence of interference of the tool (20) based on the relative positions of the tool (20) and the workpiece (W) and the indexing angle in the confirmation data, and
the data output unit (13a) includes, in the confirmation data, a determination result obtained by the interference determination unit (14).

### (Additional Remark 5)

In the information generation device (10a) above,
the interference determination unit (14) determines interference in consideration of a mechanical structure that performs the lathe machining.

### (Additional Remark 6)

An information display device (60a) includes
the information generation device (10, 10a) above,
a route/workpiece drawing unit (15) that draws the movement route and the workpiece (W), and
a tool drawing unit (16) that draws the tool (20) based on the confirmation data.

### (Additional Remark 7)

An information display device (60) includes
the information generation device (10a) above,
a route/workpiece drawing unit (15) that draws the movement route and the workpiece (W),
a tool drawing unit (16) that draws the tool (20) based on the confirmation data, and
a display form changing unit (17) that displays, in a case where the interference determination unit of the information generation device determines that there is interference between the tool (20) and the workpiece (W), at least any one of the drawn movement route, workpiece (W), or tool (20) in a different form.

### EXPLANATION OF REFERENCE NUMERALS

10, 10a Information Generation Device
11 Analysis Unit
12 Tool Shape Acquisition Unit
13, 13a Data Output Unit
14 Interference Determination Unit
15 Route/Workpiece Drawing Unit
16 Tool Drawing Unit
17 Display Form Changing Unit
20 Tool
21 to 23 Component
60, 60a Information Display Device

1. An information generation device for generating information on a program for performing lathe machining on a workpiece with a tool, comprising:
an analysis unit that generates, from the program, command data including at least a predetermined position of the tool at a predetermined point on a movement route and a relative indexing angle between the tool and the workpiece at the predetermined position;
a tool shape acquisition unit that acquires shape information on at least one or more components forming the tool; and
a data output unit that outputs, based on the command data and the shape information, confirmation data including relative positions of the workpiece and the tool on the movement route generated by interpolation performed on the predetermined position, the indexing angle, and the shape information.

2. The information generation device according to claim 1, wherein the component is wherein the component is at least one or more selected from a turret that stores the tool, a holder that stores the tool, a shank of the tool, or a blade edge of the tool.

3. The information generation device according to claim 1, wherein the data output unit
executes rotation processing of acquiring an indexing angle corresponding to the relative positions of the workpiece and the tool on the movement route and rotating the shape information according to the acquired indexing angle, and
outputs, as the confirmation data, the shape information after rotation in association with the relative positions of the workpiece and the tool.

4. The information generation device according to claim 1, further comprising:
an interference determination unit that determines occurrence of interference of the tool based on the relative positions of the tool and the workpiece and the indexing angle in the confirmation data,
wherein the data output unit includes, in the confirmation data, a determination result obtained by the interference determination unit.

5. The information generation device according to claim 4, wherein the interference determination unit determines interference in consideration of a mechanical structure that performs the lathe machining.

6. An information display device comprising:
the information generation device according to claim 1;
a route/workpiece drawing unit that draws the movement route and the workpiece; and
a tool drawing unit that draws the tool based on the confirmation data.

7. An information display device comprising:
the information generation device according to claim 5;
a route/workpiece drawing unit that draws the movement route and the workpiece;
a tool drawing unit that draws the tool based on the confirmation data; and
a display form changing unit that displays, in a case where the interference determination unit of the information generation device determines that there is interference between the tool and the workpiece, at least any one of the drawn movement route, workpiece, or tool in a different form.
